(19) United States
(12) Patent Application Publication
(10) Pub. No.: US 2022/0332144 A1
(43) Pub. Date: Oct. 20, 2022

(54) Caster

(71) Applicant: NIPPON THOMPSON CO., LTD., Tokyo (JP)

(72) Inventor: Kenichiro TSURUTA, Mino-shi, Gifu (JP)

(21) Appl. No.: 17/764,260

(22) PCT Filed: Sep. 8, 2020
(86) PCT No.: PCT/JP2020/033915

§ 371 Date: Mar. 28, 2022

(30) Foreign Application Priority Data
Sep. 27, 2019 (JP) 2019-177930

(51) Int. Cl. B60B 33/00; F16C 19/16; F16C 19/36

(52) U.S. Cl. CPC B60B 33/00; F16C 19/16; F16C 19/36

(57) ABSTRACT

A caster 1 includes a wheel 10, a fork 20, a second member 20, and a rolling bearing 40. The rolling bearing includes an outer ring 40A, an inner ring 40B, and a plurality of rolling elements. The outer ring 40A includes a first outer ring 41 and a second outer ring 42. The inner ring 40B includes a first inner ring 43 and a second inner ring 44.

### TECHNICAL FIELD

The present invention relates to a caster. The present application claims priority based on Japanese Patent Application No. 2019-177930 filed on Sep. 27, 2019, the entire contents of which are incorporated herein by reference.

### BACKGROUND ART

A caster may include a rolling bearing (swing bearing) that can rotate about an axis intersecting the rotational axis of a wheel (see, for example, Patent Literatures 1 to 4).

### CITATION LIST

### Patent Literature

Patent Literature 1: Japanese Patent Application Laid-Open No. 2012-051452
Patent Literature 2: Japanese Patent Application Laid-Open No. 2006-159951
Patent Literature 3: Japanese Patent Application Laid-Open No. H04-287703
Patent Literature 4: Japanese Patent Application Laid-Open No. H04-237603

### SUMMARY OF INVENTION

### Technical Problem

The above caster is preferably light in weight. In the above caster, downsizing in the height direction of the swing bearing may be required. In the above caster, reduction in production cost is preferable. Therefore, one of the objects is to provide a caster that can achieve weight reduction as well as downsizing in the height direction of the swing bearing portion and also reduce the production cost.

### Solution to Problem

A caster according to the present invention includes: a wheel; a first member holding the wheel so as to allow the wheel to rotate about a first rotational axis; a second member arranged apart from the first member; and a rolling bearing (swing bearing) arranged between the first member and the second member, having a second rotational axis that intersects the first rotational axis, and supporting the first member with respect to the second member so as to allow the first member to rotate about the second rotational axis. The rolling bearing includes an outer ring fixed to one of the first and second members, an inner ring fixed to the other of the first and second members, and a plurality of rolling elements arranged to be able to roll on an inner circumferential surface of the outer ring and an outer circumferential surface of the inner ring. The outer ring includes a first outer ring made of a steel plate, having a central axis that coincides with the second rotational axis, and having an annular first rolling surface that constitutes the inner circumferential surface of the outer ring, and a second outer ring made of a steel plate, having a central axis that coincides with the second rotational axis, and having an annular second rolling surface that constitutes the inner circumferential surface of the outer ring, the second outer ring being arranged alongside the first outer ring in a first axis direction in which the second rotational axis extends and being fixed to the first outer ring. The inner ring includes a first inner ring made of a steel plate, having a central axis that coincides with the second rotational axis, and having an annular third rolling surface that opposes the second rolling surface and constitutes the outer circumferential surface of the inner ring, and a second inner ring made of a steel plate, having a central axis that coincides with the second rotational axis, and having an annular fourth rolling surface that opposes the first rolling surface and constitutes the outer circumferential surface of the inner ring, a line segment connecting the fourth rolling surface and the first rolling surface and a line segment connecting the second rolling surface and the third rolling surface intersecting in a cross section including the second rotational axis, the second inner ring being arranged alongside the first inner ring in the first axis direction and being fixed to the first inner ring.

### Advantageous Effects of Invention

According to the above-described caster, weight reduction as well as downsizing in the height direction of the bearing portion can be achieved, and the production cost can also be reduced.

### BRIEF DESCRIPTION OF DRAWINGS

FIG. 1 is a schematic perspective view showing the structure of a caster in Embodiment 1;

FIG. 2 is a schematic cross-sectional view showing the structure of the caster in Embodiment 1;

FIG. 3 is a schematic cross-sectional view showing the structure of the caster in Embodiment 1;

FIG. 4 is a schematic perspective view showing the structure of a rolling bearing;

FIG. 5 is a schematic perspective view showing the structure of the rolling bearing with the first outer ring and the first inner ring removed;

FIG. 6 is a schematic cross-sectional view showing the structure of the rolling bearing;

FIG. 7 is a schematic cross-sectional view showing the structure of the rolling bearing;

FIG. 8 is a schematic diagram illustrating the state of grain flows in the outer and inner rings;

FIG. 9 is a schematic cross-sectional view showing the structure of the rolling bearing;

FIG. 10 is a schematic cross-sectional view showing the structure of the rolling bearing;

FIG. 11 is a schematic cross-sectional view showing the structure of the rolling bearing included in the caster in a first variation of Embodiment 1;

FIG. 12 is a schematic perspective view showing the structure of a caster in Embodiment 2;

FIG. 13 is a schematic cross-sectional view showing the structure of the caster in Embodiment 2;

FIG. 14 is a schematic cross-sectional view showing the structure of the caster in Embodiment 2;

FIG. 15 is a schematic perspective view showing the structure of a fixing member;

FIG. 16 is a schematic perspective view showing the structure of a cover member;

FIG. 17 is a schematic perspective view showing the structure of a caster in Embodiment 3;

FIG. 18 is a schematic cross-sectional view showing the structure of the caster in Embodiment 3; and

FIG. 19 is a schematic cross-sectional view showing the structure of the caster in Embodiment 3.

### DESCRIPTION OF EMBODIMENTS

### Outline of Embodiments

First, embodiments of the present disclosure will be listed and described. A caster of the present disclosure includes: a wheel; a first member holding the wheel so as to allow the wheel to rotate about a first rotational axis; a second member arranged apart from the first member; and a rolling bearing arranged between the first member and the second member, having a second rotational axis that intersects the first rotational axis, and supporting the first member with respect to the second member so as to allow the first member to rotate about the second rotational axis. The rolling bearing includes an outer ring fixed to one of the first and second members, an inner ring fixed to the other of the first and second members, and a plurality of rolling elements arranged to be able to roll on an inner circumferential surface of the outer ring and an outer circumferential surface of the inner ring. The outer ring includes a first outer ring made of a steel plate, having a central axis that coincides with the second rotational axis, and having an annular first rolling surface that constitutes the inner circumferential surface of the outer ring, and a second outer ring made of a steel plate, having a central axis that coincides with the second rotational axis, and having an annular second rolling surface that constitutes the inner circumferential surface of the outer ring, the second outer ring being arranged alongside the first outer ring in a first axis direction in which the second rotational axis extends and being fixed to the first outer ring. The inner ring includes a first inner ring made of a steel plate, having a central axis that coincides with the second rotational axis, and having an annular third rolling surface that opposes the second rolling surface and constitutes the outer circumferential surface of the inner ring, and a second inner ring made of a steel plate, having a central axis that coincides with the second rotational axis, and having an annular fourth rolling surface that opposes the first rolling surface and constitutes the outer circumferential surface of the inner ring, a line segment connecting the fourth rolling surface and the first rolling surface and a line segment connecting the second rolling surface and the third rolling surface intersecting in a cross section including the central axis of the first rolling surface, the second inner ring being arranged alongside the first inner ring in the first axis direction and being fixed to the first inner ring.

In the caster of the present disclosure, the first outer ring, the second outer ring, the first inner ring, and the second inner ring are made of steel plates. The first outer ring, the second outer ring, the first inner ring, and the second inner ring as described above can be formed by performing plastic working on the steel plates. The production cost of the rolling bearing can thus be reduced. This results in a reduced production cost of the caster. With the first outer ring, the second outer ring, the first inner ring, and the second inner ring being made of steel plates, the first outer ring, the second outer ring, the first inner ring, and the second inner ring can be made light in weight and thin-walled. This results in weight reduction of the caster and its size reduction in the height direction of the bearing portion. As such, according to the caster of the present disclosure, weight reduction as well as downsizing in the height direction of the bearing portion can be achieved, and the production cost can also be reduced.

In the above caster, in a cross section including the second rotational axis, grain flows in a steel constituting the first outer ring may extend along the first rolling surface, grain flows in a steel constituting the second outer ring may extend along the second rolling surface, grain flows in a steel constituting the first inner ring may extend along the third rolling surface, and grain flows in a steel constituting the second inner ring may extend along the fourth rolling surface. If the ends of the grain flows of the steel constituting the inner and outer rings contact the rolling elements, the durability of the inner and outer rings may be reduced. Adopting the first outer ring, the second outer ring, the first inner ring, and the second inner ring having the above configurations can suppress the contact of the rolling elements with the ends of the steel grain flows. This results in improved durability of the inner and outer rings.

In the above caster, the first outer ring may include a first portion having a disk annular shape, a second portion having a tubular shape and having an annular inner circumferential surface, the second portion extending from an inner edge of the first portion such that an inner diameter of the second portion decreases with increasing distance from the first portion in the first axis direction, and a third portion having a cylindrical shape, being connected to an end of the second portion opposite to the first portion in the first axis direction, and extending along the first axis direction. The second outer ring may include a fourth portion having a disk annular shape and being fixed to the first portion such that main surfaces thereof contact each other, a fifth portion having a tubular shape and having an annular inner circumferential surface, the fifth portion extending from an inner edge of the fourth portion to a side opposite to the second portion in the first axis direction, the fifth portion having an inner diameter decreasing with increasing distance from the fourth portion, and a sixth portion having a cylindrical shape, being connected to an end of the fifth portion opposite to the fourth portion in the first axis direction, and extending along the first axis direction to a side opposite to the third portion. The first inner ring may include a seventh portion having a disk annular shape, an eighth portion having a tubular shape and having an annular outer circumferential surface, the eighth portion extending from an outer edge of the seventh portion such that an outer diameter of the eighth portion increases with increasing distance from the seventh portion in the first axis direction, and a ninth portion having a cylindrical shape, being connected to an end of the eighth portion opposite to the seventh portion in the first axis direction, and extending along the first axis direction. The second inner ring may include a tenth portion having a disk annular shape and being fixed to the seventh portion such that main surfaces thereof contact each other, an eleventh portion having a tubular shape and having an annular outer circumferential surface, the eleventh portion extending from an outer edge of the tenth portion to a side opposite to the eighth portion in the first axis direction such that an outer diameter of the eleventh portion increases with increasing distance from the tenth portion, and a twelfth portion having a cylindrical shape, being connected to an end of the eleventh portion opposite to the tenth portion in the first axis direction, and extending along the first axis direction to a side opposite to the ninth portion. The inner circumferential surface of the second portion may include the first rolling surface. The inner circumferential surface of the fifth portion may include the second rolling surface. The outer circumferential surface of the eighth portion may include the third rolling surface. The outer circumferential surface of the eleventh portion may include the fourth rolling surface.

The first outer ring, the second outer ring, the first inner ring, and the second inner ring with the above configurations can readily be produced by, for example, press forming the steel plates. This can further reduce the production cost of the caster.

In the above caster, in a cross section including the second rotational axis, the main surface of the first portion in contact with the fourth portion and the first rolling surface may be connected via a curved first region. The main surface of the fourth portion in contact with the first portion and the second rolling surface may be connected via a curved second region. An annular space may be formed enclosed by the first region, the second region, and the rolling elements. The annular space as described above can hold a lubricant. This can reduce the risk of occurrence of oil film shortage between the rolling elements and the rolling surfaces.

In the above caster, the third portion may have an inner circumferential surface opposing an outer circumferential surface of the ninth portion. The sixth portion may have an inner circumferential surface opposing an outer circumferential surface of the twelfth portion. In a cross section including the second rotational axis, a distance in a radial direction between the third portion and the ninth portion may be smaller than a thickness of the third portion, and a distance in the radial direction between the sixth portion and the twelfth portion may be smaller than a thickness of the sixth portion. Such a configuration can reduce the entry of foreign matter into the space enclosed by the first outer ring, the second outer ring, the first inner ring, and the second inner ring from a gap formed between the third and ninth portions and a gap formed between the sixth and twelfth portions.

In the above caster, the rolling elements may be balls. The rolling elements may be arranged so as to be able to roll on the first rolling surface, the second rolling surface, the third rolling surface, and the fourth rolling surface. This can reduce the torque of the rolling bearing.

In the above caster, the rolling elements may include first rollers and second rollers. The first rollers and the second rollers may be arranged alternately in a circumferential direction. The first rollers and the second rollers may have central axes intersecting each other. The first rollers may be arranged so as to be able to roll on the first and fourth rolling surfaces. The second rollers may be arranged so as to be able to roll on the second and third rolling surfaces. With the rolling elements including the first and second rollers as described above, the rolling bearing is suitable for supporting loads applied in a plurality of directions. When a rolling bearing capable of receiving a load in one direction is used in a caster, it is necessary to arrange a plurality of rolling bearings to support loads applied in the plurality of directions. The rolling bearing of the present disclosure can suppress the increase in the number of bearings to be used, and can also achieve downsizing of the caster in the height direction.

### DESCRIPTION OF SPECIFIC EMBODIMENTS

Specific embodiments of the caster of the present disclosure will be described below with reference to the drawings. In the drawings referenced below, the same or corresponding portions are denoted by the same reference numerals and the description thereof will not be repeated.

### Embodiment 1

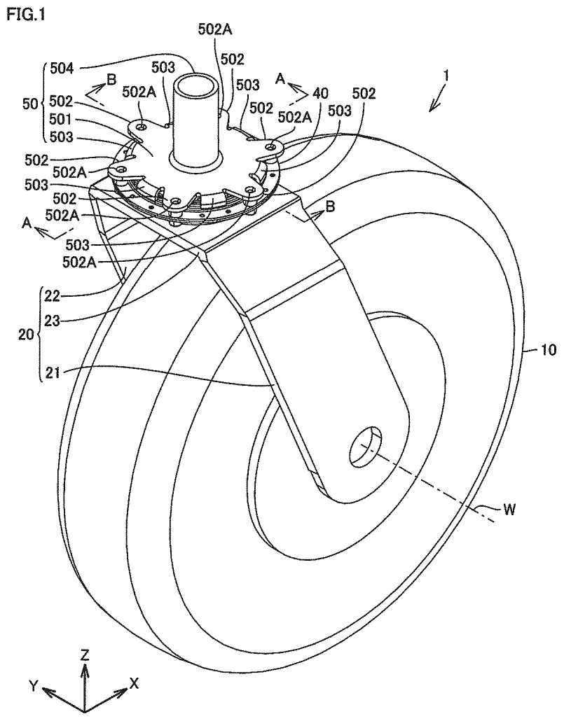

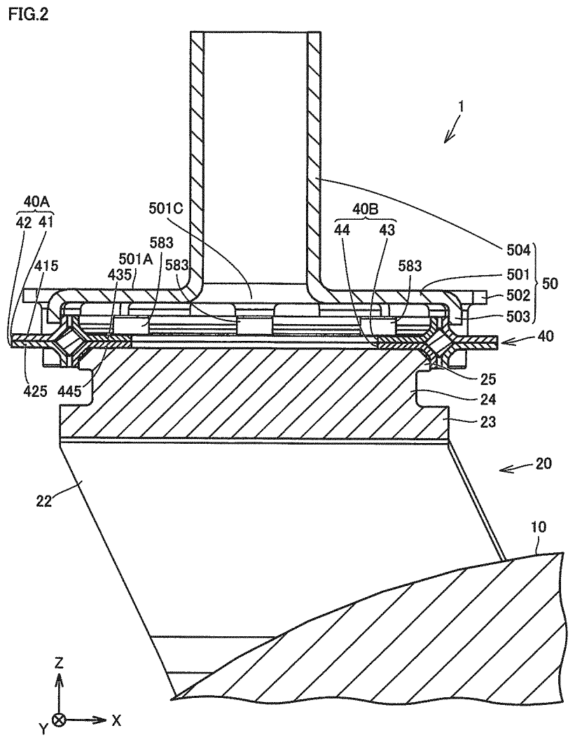

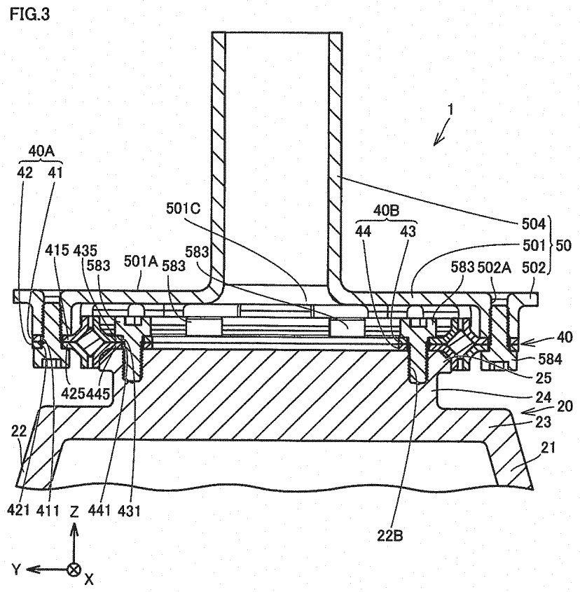

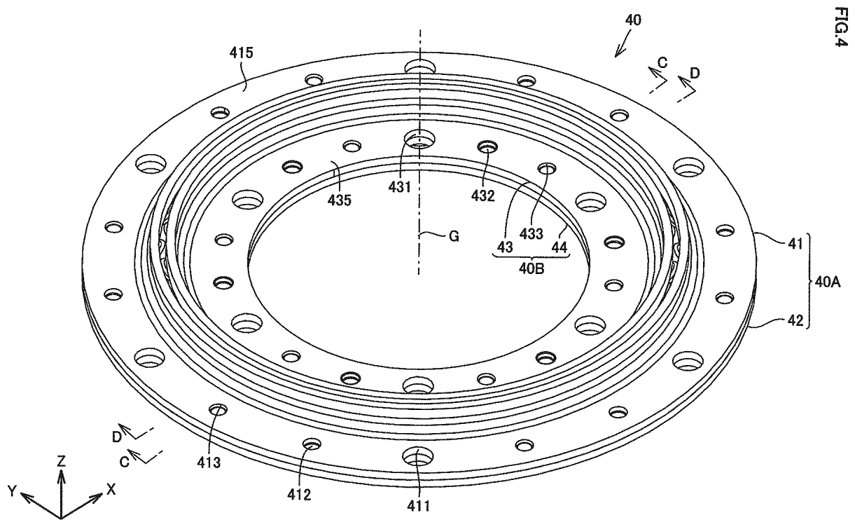

FIG. 1 is a schematic perspective view showing the structure of a caster in Embodiment 1. In FIG. 1, the Z axis direction is a direction along a first axis direction in which a second rotational axis G of a rolling bearing extends. FIG. 2 is a cross-sectional view of the caster when cut at A-A in FIG. 1. FIG. 3 is a cross-sectional view of the caster when cut at B-B in FIG. 1. Referring to FIGS. 3 and 4, the caster 1 in Embodiment 1 includes a wheel 10, a fork 20 as a first member that holds the wheel 10 so as to be able to rotate about a first rotational axis W, a rolling bearing 40, a mounting portion 50 as a second member, and bolts 583, 584. Referring to FIGS. 1 to 3, the fork 20 includes a pair of support portions 21, 22 and a connecting portion 23. The pair of support portions 21, 22 have their tip ends around which they support the center of the wheel 10, and extend along the radial direction of the wheel 10. The connecting portion 23 connects the support portions 21 and 22. The connecting portion 23 includes a pedestal portion 24 and a flange portion 25. The pedestal portion 24 is disposed at the center of the connecting portion 23 in the axial direction (Y axis direction) of the wheel 10. The pedestal portion 24 has a columnar shape. The pedestal portion 24 is greater in thickness than the other region of the connecting portion 23. The pedestal portion 24 has a plurality of screw holes 22B formed at equal intervals in the circumferential direction. The flange portion 25 is disposed to protrude in the radial direction from an outer edge of a region including an end face of the pedestal portion 24 on the opposite side of the support portions 21, 22. The flange portion 25 has an annular shape.

The mounting portion 50 is arranged apart from the fork 20 in the Z axis direction. The mounting portion 50 includes a body portion 501, protruding portions 502, hook portions 503, and a shaft portion 504. The body portion 501 has a disk shape. When viewed in a plane in the Z axis direction, the body portion 501 has a through hole 501C formed at the center to penetrate in the thickness direction. The protruding portions 502 protrude in the radial direction from the outer circumference of the body portion 501. A plurality of protruding portions 502 are arranged at equal intervals in the circumferential direction. Each protruding portion 502 has a screw hole 502A formed to penetrate along the Z axis direction. The hook portions 503 extend along the Z axis direction from the outer circumference of the body portion 501. Each hook portion 503 is arranged between adjacent protruding portions 502 in the circumferential direction. A plurality of hook portions 503 are arranged at equal intervals in the circumferential direction. The shaft portion 504 protrudes along the Z axis direction from one surface 501A of the body portion 501 in the thickness direction. The shaft portion 504 has a hollow cylindrical shape. The shaft portion 504 is disposed such that the space enclosed by the inner wall of the shaft portion 504 communicates with the through hole 501C. The shaft portion 504 is inserted into a slot that is formed in a member to which the caster 1 is to be attached, and is fixed using a screw or other member.

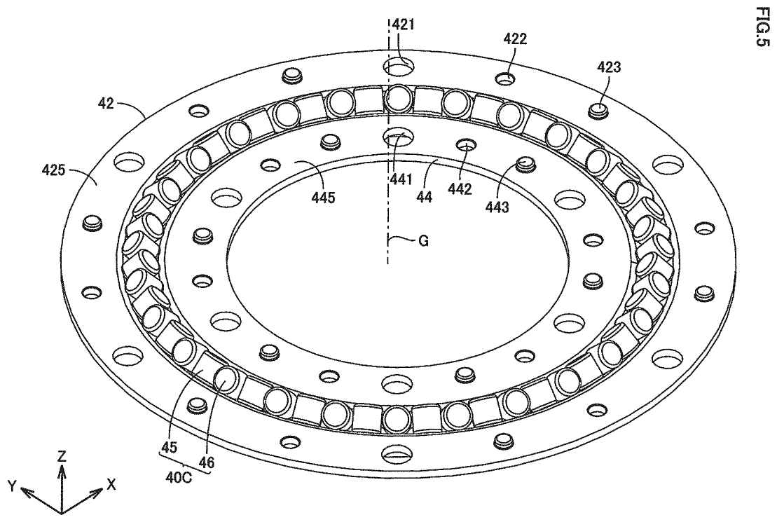

Referring to FIGS. 4 and 5, the rolling bearing 40 includes an outer ring 40A, an inner ring 40B, and rollers 40C as rolling elements. In the present embodiment, the outer ring 40A and the inner ring 40B are made of steel plates that have been worked into a predetermined shape. In the present embodiment, the steel constituting the outer ring 40A and the inner ring 40B is, for example, SCM415 specified in JIS standard.

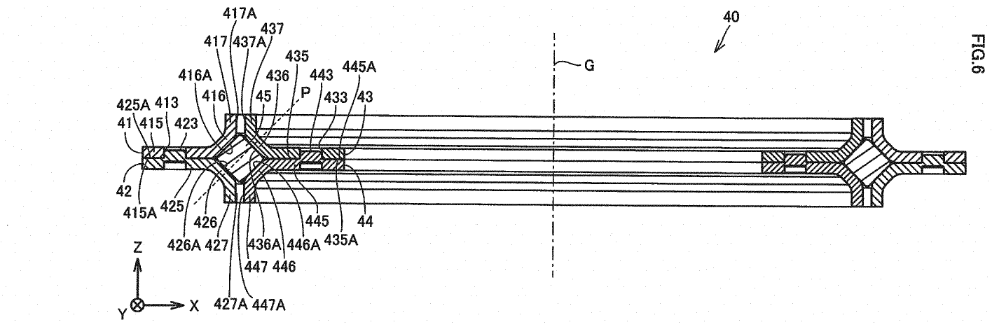

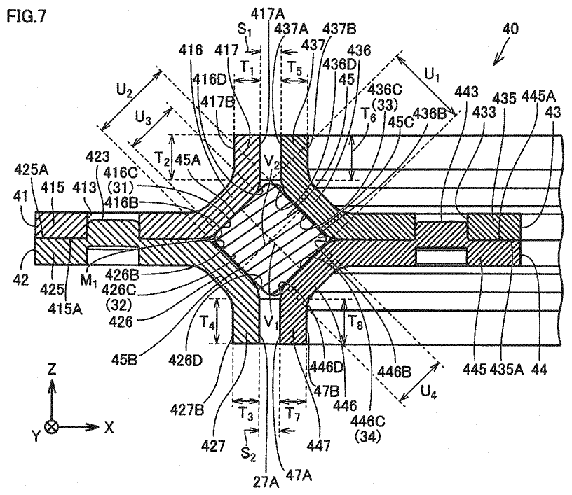

FIG. 6 is a cross-sectional view of the rolling bearing 40 when cut at C-C in FIG. 4. FIG. 6 is a cross-sectional view including the central axis of a first roller, which will be described later. FIG. 7 is a cross-sectional diagram showing, in an enlarged view, the area around the first roller in FIG. 6. Referring to FIGS. 4 and 6, the outer ring 40A includes an annular first outer ring 41 and an annular second outer ring 42. Referring to FIGS. 6 and 7, the first outer ring 41 includes a first portion 415, a second portion 416, and a third portion 417. In the present embodiment, the first portion 415, the second portion 416, and the 3rd portion 417 have the same thickness. The first portion 415 has a disk annular shape. The first portion 415 has a central axis that coincides with the rotational axis G of the rolling bearing 40. The second portion 416 has a tubular shape. The external shape of the second portion 416 is a truncated cone shape. The second portion 416 extends from an inner edge of the first portion 415 such that its inner diameter decreases with increasing distance from the first portion 415 in the Z axis direction. The second portion 416 has an inner circumferential surface 416A of an annular shape. The inner circumferential surface 416A has a common central axis with the rotational axis G of the rolling bearing 40. The third portion 417 has a cylindrical shape. The third portion 417 has a common central axis with the rotational axis G of the rolling bearing 40. The third portion 417 is connected to an end of the second portion 416 opposite to the first portion 415 in the Z axis direction and extends along the Z axis direction.

Referring to FIGS. 6 and 7, the inner circumferential surface 416A includes an annular first surface 416B as a first region, an annular second surface 416C, and an annular third surface 416D as a third region. In the present embodiment, the first surface 416B, the second surface 416C, and the third surface 416D have a common central axis with the rotational axis G of the rolling bearing 40. The first surface 416B connects a surface 415A of the first portion 415 on the side that contacts a fourth portion 425 to the second surface 416C. In the present embodiment, in the cross section including the rotational axis G, the first surface 416B has a curved shape. In the cross section including the rotational axis G, the second surface 416C has a flat shape. The third surface 416D connects the second surface 416C to an inner circumferential surface 417A of the third portion 417. In the present embodiment, in the cross section including the rotational axis G, the third surface 416D has a curved shape. In the present embodiment, in the cross section including the rotational axis G, the third portion 417 has a length T₂ in the Z axis direction that is greater than 1.5 times the thickness T₁ of the third portion 417. The length T₂ of the third portion 417 in the Z axis direction is preferably not more than five times the thickness T₁ of the third portion 417. The thickness T₁ of the third portion 417 in the present embodiment is, for example, about 1 mm.

Referring to FIG. 4, the first portion 415 has a plurality of (in the present embodiment, six) mounting holes 411, penetrating in the thickness direction (Z axis direction), formed at equal intervals in the circumferential direction. In the first portion 415, a protruding portion 412 and a through hole 413 are formed side by side in the circumferential direction between adjacent mounting holes 411 in the circumferential direction. A plurality of (in the present embodiment, six) protruding portions 412, protruding in the Z axis direction from the surface 415A of the first portion 415, are formed at equal intervals in the circumferential direction. A plurality of (in the present embodiment, six) through holes 413, penetrating in the thickness direction (Z axis direction), are formed at equal intervals in the circumferential direction.

Referring to FIGS. 6 and 7, the second outer ring 42 is arranged alongside the first outer ring 41 in the Z axis direction and is fixed to the first outer ring 41. The second outer ring 42 includes a fourth portion 425, a fifth portion 426, and a sixth portion 427. In the present embodiment, the fourth portion 425, the fifth portion 426, and the sixth portion 427 have the same thickness T₃. In the present embodiment, the thickness T₃ coincides with the thickness T₁. The fourth portion 425 has a disk annular shape. The surface 415A of the first portion 415 is in contact with one surface 425A in the thickness direction of the fourth portion 425. The fourth portion 425 has a central axis that coincides with the rotational axis G of the rolling bearing 40. The fifth portion 426 has a tubular shape. The external shape of the fifth portion 426 is a truncated cone shape. The fifth portion 426 extends from the inner edge of the fourth portion 425 such that its inner diameter decreases with increasing distance from the fourth portion 425 in the Z axis direction. The fifth portion 426 extends to the opposite side of the second portion 416 in the Z axis direction. The fifth portion 426 has an inner circumferential surface 426A of an annular shape. The inner circumferential surface 426A has a central axis that coincides with the rotational axis G of the rolling bearing 40. The sixth portion 427 has a cylindrical shape. The sixth portion 427 has a central axis that coincides with the rotational axis G of the rolling bearing 40. The sixth portion 427 is connected to an end of the fifth portion 426 opposite to the fourth portion 425 in the Z axis direction and extends along the Z axis direction to the opposite side of the third portion 417.

Referring to FIGS. 6 and 7, the inner circumferential surface 426A includes an annular fourth surface 426B as a second region, an annular fifth surface 426C, and an annular sixth surface 426D. The fourth surface 426B, the fifth surface 426C, and the sixth surface 426D have a central axis that coincides with the rotational axis G of the rolling bearing 40. The fourth surface 426B connects the surface 425A of the fourth portion 425 to the fifth surface 426C. In the cross section including the rotational axis G, the fourth surface 426B has a curved shape. In the cross section including the rotational axis G, the fifth surface 426C has a flat shape. The sixth surface 426D connects the fifth surface 426C to an inner circumferential surface 427A of the sixth portion 427. In the cross section including the rotational axis G, the sixth surface 426D has a curved shape. In the present embodiment, in the cross section including the rotational axis G, the sixth portion 427 has a length T₄ in the Z axis direction that is greater than 1.5 times the thickness T₃ of the sixth portion 427. The length T₄ of the sixth portion 427 in the Z axis direction is preferably not more than five times the thickness T₃ of the sixth portion 427. The thickness T₃ of the sixth portion 427 in the present embodiment is, for example, about 1 mm.

Referring to FIGS. 5 and 6, the fourth portion 425 has a plurality of (in the present embodiment, six) mounting holes 421, penetrating in the thickness direction (Z axis direction), formed at equal intervals in the circumferential direction. In the fourth portion 425, a through hole 422 and a protruding portion 423 are formed side by side in the circumferential direction between adjacent mounting holes 421 in the circumferential direction. A plurality of (in the present embodiment, six) through holes 422, penetrating in the thickness direction (Z axis direction), are formed at equal intervals in the circumferential direction. Each through hole 422 has a shape corresponding to the protruding portion 412. A plurality of (in the present embodiment, six) protruding portions 423, protruding in the Z axis direction from the surface 425A of the fourth portion 425, are formed at equal intervals in the circumferential direction. Each protruding portion 423 has a shape corresponding to the through hole 413.

Referring to FIG. 4, the inner ring 40B includes an annular first inner ring 43 and an annular second inner ring 44. Referring to FIGS. 4 and 6, the first inner ring 43 includes a seventh portion 435, an eighth portion 436, and a ninth portion 437. In the present embodiment, the seventh portion 435, the eighth portion 436, and the ninth portion 437 have the same thickness T₅. In the present embodiment, the thickness T₅ coincides with the thickness T₁. The seventh portion 435 has a disk annular shape. The seventh portion 435 has a central axis that coincides with the rotational axis G of the rolling bearing 40. The eighth portion 436 has a tubular shape. The external shape of the eighth portion 436 is a truncated cone shape. The eighth portion 436 extends from the outer edge of the seventh portion 435 such that its outer diameter decreases with increasing distance from the seventh portion 435 in the Z axis direction. The eighth portion 436 has an annular outer circumferential surface 436A. The outer circumferential surface 436A has a common central axis with the rotational axis G of the rolling bearing 40. The ninth portion 437 has a cylindrical shape. The ninth portion 437 has a common central axis with the rotational axis G of the rolling bearing 40. The ninth portion 437 is connected to an end of the eighth portion 436 opposite to the seventh portion 435 in the Z axis direction and extends along the Z axis direction.

Referring to FIGS. 6 and 7, the outer circumferential surface 436A includes an annular seventh surface 436B, an annular eighth surface 436C, and an annular ninth surface 436D as a fourth region. The seventh surface 436B, the eighth surface 436C, and the ninth surface 436D have a common central axis with the rotational axis G of the rolling bearing 40. The seventh surface 436B connects a surface 435A of the seventh portion 435 on the side in contact with a tenth portion 445 to the eighth surface 436C. In the cross section including the rotational axis G, the seventh surface 436B has a curved shape. In the cross section including the rotational axis G, the eighth surface 436C has a flat shape. The eighth surface 436C opposes the fifth surface 426C. In the present embodiment, in the cross section including the rotational axis G, the eighth surface 436C and the fifth surface 426C are arranged in parallel. The ninth surface 436D connects the eighth surface 436C to an outer circumferential surface 437A of the ninth portion 437. In the cross section including the rotational axis G, the ninth surface 436D has a curved shape. In the present embodiment, in the cross section including the rotational axis G, the ninth portion 437 has a length T₆ in the Z axis direction that is greater than 1.5 times the thickness T₅ of the ninth portion 437. The length T₆ in the Z axis direction of the ninth portion 437 is preferably not more than five times the thickness T₅ of the ninth portion 437. The thickness T₅ of the ninth portion 437 in the present embodiment is, for example, about 1 mm. In the present embodiment, a distance S₁ in the radial direction between the third portion 417 and the ninth portion 437 in the cross section including the rotational axis G is smaller than the thickness T₁ of the third portion 417 and the thickness T₅ of the ninth portion 37.

Referring to FIG. 4, the seventh portion 435 has a plurality of (in the present embodiment, six) mounting holes 431, penetrating in the thickness direction (Z axis direction), formed at equal intervals in the circumferential direction. In the seventh portion 435, a protruding portion 432 and a through hole 433 are formed side by side in the circumferential direction between adjacent mounting holes 431 in the circumferential direction. A plurality of (in the present embodiment, six) protruding portions 432, protruding in the Z axis direction from the surface 435A of the seventh portion 435, are formed at equal intervals in the circumferential direction. A plurality of (in the present embodiment, six) through holes 433, penetrating in the thickness direction (Z axis direction), are formed at equal intervals in the circumferential direction.

Referring to FIGS. 6 and 7, the second inner ring 44 is arranged alongside the first inner ring 43 in the Z axis direction and is fixed to the first inner ring 43. The second inner ring 44 includes a tenth portion 445, an eleventh portion 446, and a twelfth portion 447. In the present embodiment, the tenth portion 445, the eleventh portion 446, and the twelfth portion 447 have the same thickness T₇. In the present embodiment, the thickness T₇ coincides with the thickness T₁. The tenth portion 445 has a disk annular shape. The surface 435A of the seventh portion 435 is in contact with one surface 445A in the thickness direction of the tenth portion 445. The tenth portion 445 has a common central axis with the rotational axis G of the rolling bearing 40. The eleventh portion 446 has a tubular shape. The external shape of the eleventh portion 446 is a truncated cone shape. The eleventh portion 446 extends from the outer edge of the tenth portion 445 such that its outer diameter increases with increasing distance from the tenth portion 445 in the Z axis direction. The eleventh portion 446 extends to the opposite side of the eighth portion 436 in the Z axis direction. The eleventh portion 446 has an annular outer circumferential surface 446A. The outer circumferential surface 446A has a common central axis with the rotational axis G of the rolling bearing 40. The twelfth portion 447 has a cylindrical shape. The twelfth portion 447 has a common central axis with the rotational axis G of the rolling bearing 40. The twelfth portion 447 is connected to an end of the eleventh portion 446 opposite to the tenth portion 445 in the Z axis direction and extends along the Z axis direction to the opposite side of the ninth portion 437.

Referring to FIGS. 6 and 7, the outer circumferential surface 446A includes an annular tenth surface 446B, an annular eleventh surface 446C, and an annular twelfth surface 446D. The tenth surface 446B, the eleventh surface 446C, and the twelfth surface 446D have a common central axis with the rotational axis G of the rolling bearing 40. The tenth surface 446B connects the surface 445A of the tenth portion 445 to the eleventh surface 446C. In a cross section including the rotational axis G, the tenth surface 446B has a curved shape. In the cross section including the rotational axis G, the eleventh surface 446C has a flat shape. The eleventh surface 446C opposes the second surface 416C. In the present embodiment, in the cross section including the rotational axis G, the eleventh surface 446C and the second surface 416C are arranged in parallel. In the cross section including the rotational axis G, a line segment V₁ connecting the second surface 416C and the eleventh surface 446C intersects (is orthogonal to) a line segment V₂ connecting the fifth surface 426C and the eighth surface 436C (see particularly FIG. 7). The twelfth surface 446D connects the eleventh surface 446C to an outer circumferential surface 447A of the twelfth portion 447. In the cross section including the rotational axis G, the twelfth surface 446D has a curved shape. In the present embodiment, in the cross section including the rotational axis G, the twelfth portion 447 has a length T₅ in the Z axis direction that is greater than 1.5 times the thickness T₇ of the twelfth portion 447. The length T₅ in the Z axis direction of the twelfth portion 447 is preferably not more than five times the thickness T₇ of the twelfth portion 447. The thickness T₁ of the twelfth portion 447 in the present embodiment is, for example, about 1 mm. In the present embodiment, a distance S₂ in the radial direction between the sixth portion 427 and the twelfth portion 447 in the cross section including the rotational axis G is smaller than the thickness T₃ of the sixth portion 427 and the thickness T₇ of the twelfth portion 447.

Referring to FIG. 5, the tenth portion 445 has a plurality of mounting holes 441, penetrating in the thickness direction (Z axis direction), formed at equal intervals in the circumferential direction. In the tenth portion 445, a through hole 442 and a protruding portion 443 are formed side by side in the circumferential direction between adjacent mounting holes 441 in the circumferential direction. A plurality of (in the present embodiment, six) through holes 442, penetrating in the thickness direction (Z axis direction), are formed at equal intervals in the circumferential direction. Each through hole 443 has a shape corresponding to the protruding portion 412. A plurality of (in the present embodiment, six) protruding portions 423, protruding in the Z axis direction from the surface 425A of the tenth portion 445, are formed at equal intervals in the circumferential direction. Each protruding portion 423 has a shape corresponding to the through holes 433.

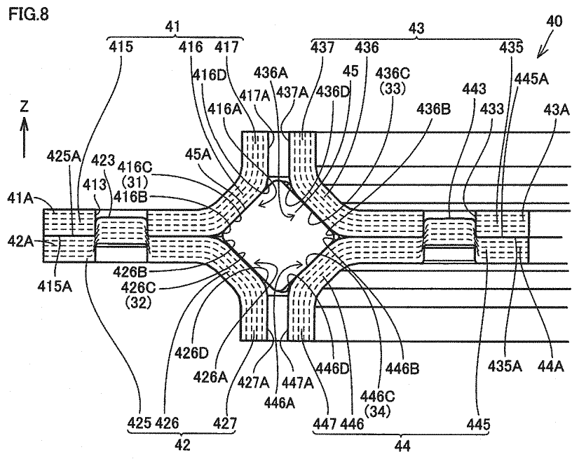

FIG. 8 is a diagram illustrating grain flows in a cross section of the rolling bearing 40 when cut at C-C in FIG. 4. Referring to FIG. 8, in the first outer ring 41, grain flows 41A in a steel that constitutes the first outer ring 41 extend continuously along the surface 415A of the first portion 415, the inner circumferential surface 416A of the second portion 416, and the inner circumferential surface 417A of the third portion 417. The grain flows 41A extend continuously along the first surface 416B, the second surface 416C, and the third surface 416D of the inner circumferential surface 416A. In the present embodiment, the grain flows 41A extend parallel to the second surface 416C. In the second outer ring 42, grain flows 42A in a steel that constitutes the second outer ring 42 extend continuously along the surface 425A of the fourth portion 425, the inner circumferential surface 426A of the fifth portion 426, and the inner circumferential surface 427A of the sixth portion 427. The grain flows 43A extend continuously along the fourth surface 426B, the fifth surface 426C, and the sixth surface 426D of the inner circumferential surface 426A. In the present embodiment, the grain flows 43A extend parallel to the fifth surface 426C. In the first inner ring 43, grain flows 43A in a steel that constitutes the first inner ring 43 extend continuously along the surface 435A of the seventh portion 435, the outer circumferential surface 436A of the eighth portion 436, and the outer circumferential surface 437A of the ninth portion 437. The grain flows 43A extend continuously along the seventh surface 436B, the eighth surface 436C, and the ninth surface 436D of the outer circumferential surface 436A. In the present embodiment, the grain flows 43A extend parallel to the eighth surface 436C. In the second inner ring 44, grain flows 43A in a steel that constitutes the second inner ring 44 extend continuously along the surface 445A of the tenth portion 445, the outer circumferential surface 446A of the eleventh portion 446, and the outer circumferential surface 447A of the twelfth portion 447. The grain flows 43A extend continuously along the tenth surface 446B, the eleventh surface 446C, and the twelfth surface 446D of the outer circumferential surface 446A. In the present embodiment, the grain flows 44A extend parallel to the eleventh surface 446C.

Referring to FIG. 5, the plurality of rollers 40C include a plurality of first rollers 45 and a plurality of second rollers 46. In the present embodiment, the first rollers 45 and the second rollers 46 are made of steel. In the present embodiment, the first rollers 45 and the second rollers 46 are made of, for example, SUJ2 specified in JIS standard. In the present embodiment, the rollers 40C include 27 first rollers 45 and 27 second rollers 46. The first rollers 45 and the second rollers 46 have a cylindrical shape. The first rollers 45 and the second rollers 46 are arranged alternately in the circumferential direction. Referring to FIG. 7, the first rollers 45 are disposed such that they can roll while contacting the second surface 416C and the eleventh surface 446C at their outer circumferential surfaces 45A. The second surface 416C constitutes a first rolling surface 31. The eleventh surface 446C constitutes a fourth rolling surface 34. Each first roller 45 has one end face 45C in the axial direction that is opposite to the eighth surface 436C. The other end face 45B in the axial direction of the first roller 45 is in contact with the fifth surface 426C. In the present embodiment, an annular space M₁ is formed which is enclosed by the first surface 416B, the fourth surface 426B, and the first roller 45.

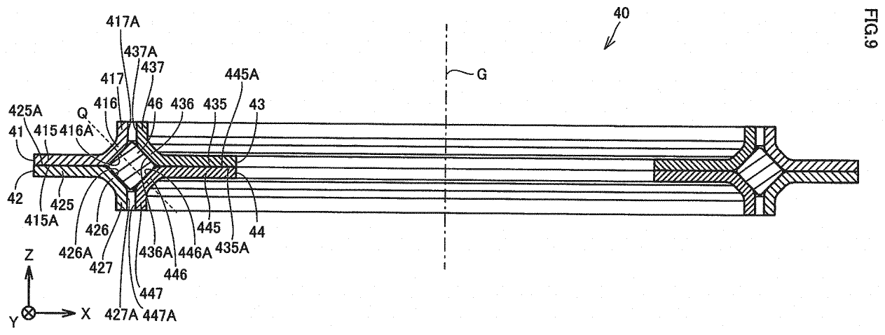

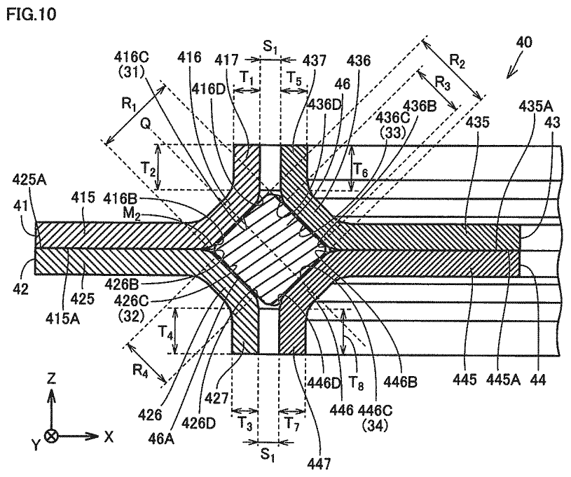

FIG. 9 is a cross-sectional view of the rolling bearing 40 when cut at D-D in FIG. 4. FIG. 9 is a cross section including the central axis of a second roller 46, which will be described below. FIG. 10 is a cross-sectional diagram showing, in an enlarged view, the area around the second roller 46 in FIG. 9. Referring to FIGS. 9 and 10, the second rollers 46 are disposed such that they can roll while contacting the fifth surface 426C and the eighth surface 436C at their outer circumferential surfaces 46A. The fifth surface 426C constitutes a second rolling surface 32. The eighth surface 436C constitutes a third rolling surface 33. Each second roller 46 has one end face 46B in the axial direction that is in contact with the second surface 416C. The other end face 46C in the axial direction of the second roller 46 is opposite to the eleventh surface 446C. In the present embodiment, an annular space M₂ is formed which is enclosed by the first surface 416B, the fourth surface 426B, and the second roller 46 (see particularly FIG. 10). Referring to FIGS. 6 and 9, the first roller 45 has a central axis P that intersects (is orthogonal to) a central axis Q of the second roller 46. Here, referring to FIGS. 6 and 9, the state in which the central axis P of the first roller 45 intersects the central axis Q of the second roller 46 means that when the center of gravity of the first roller 45 and the second roller 46 passes through a predetermined point during rotation of the rolling bearing 40, the central axis P of the first roller 45 and the central axis Q of the second roller 46 intersect with (are orthogonal to) each other.

Referring to FIGS. 7 and 10, in the present embodiment, in the cross section including the rotational axis G, the thickness T₁ of the first portion 415, the second portion 416, and the third portion 417 is less than 0.5 times a diameter U₁ of the first roller 45 and a diameter R₁ of the second roller 46. The thickness T₃ of the fourth portion 425, the fifth portion 426, and the sixth portion 427 is less than 0.5 times the diameter U₁ of the first roller 45 and the diameter R₁ of the second roller 46. The thickness T₅ of the seventh portion 435, the eighth portion 436, and the ninth portion 437 is less than 0.5 times the diameter U₁ of the first roller 45 and the diameter R₁ of the second roller 46. The thickness T₇ of the tenth portion 445, the eleventh portion 446, and the twelfth portion 447 is less than 0.5 times the diameter U₁ of the first roller 45 and the diameter R₁ of the second roller 46. In the cross section including the rotational axis G, an effective contact length L₁ between the outer circumferential surface 45A of the first roller 45 and the second surface 416C and an effective contact length L₂ between the outer circumferential surface 45A and the eleventh surface 446C are not less than 0.5 times and not more than 0.9 times a length U₂ in the axial direction of the first roller 45. In the cross section including the rotational axis G, an effective contact length L3 between the outer circumferential surface 46A of the second roller 46 and the fifth surface 426C and an effective contact length La between the outer circumferential surface 46A and the eighth surface 436C are not less than 0.5 times and not more than 0.9 times a length R₂ in the axial direction of the second roller 46.

Referring to FIG. 2, the rolling bearing 40 is installed on the fork 20 as the second inner ring 44 is fitted onto the flange portion 25. Referring to FIG. 3, the rolling bearing 40 is placed such that the positions where the mounting holes 431 are formed in the seventh portion 435, the positions where the mounting holes 441 are formed in the tenth portion 445, and the positions where the screw holes 22B are formed coincide with each other, and the bolts 583 are screwed into the screw holes 22B through the mounting holes 431 and 441. In this manner, the first inner ring 43 and the second inner ring 44 are fixed to the fork 20. Referring to FIG. 2, the mounting portion 50 is installed on the rolling bearing 40 as the hook portions 503 are fitted onto the first outer ring 41. Referring to FIG. 3, the mounting portion 50 is placed such that the positions where the mounting holes 411 are formed in the first portion 415, the positions where the mounting holes 421 are formed in the fourth portion 425, and the positions where the screw holes 502A are formed coincide with each other, and the bolts 584 are screwed into the screw holes 502 through the mounting holes 411 and 421. In this manner, the first outer ring 41 and the second outer ring 42 are fixed to the mounting portion 50. Thus, with the rolling bearing 40 installed, the fork 20 is supported with respect to the mounting portion 50 so as to be rotatable in the circumferential direction of the rolling bearing 40. The hook portions 503 abutting against the outer circumferential surface of the first outer ring 41 and the flange portion 25 abutting against the inner circumferential surface of the second inner ring 44 facilitate the centering of the rolling bearing 40.

Here, in the caster 1 in the present embodiment, the first outer ring 41, the second outer ring 42, the first inner ring 43, and the second inner ring 44 are made of steel plates. The first outer ring 41, the second outer ring 42, the first inner ring 43, and the second inner ring 44 as described above can be formed by performing plastic working (for example, press working in the present embodiment) on the steel plates. With the production cost of the rolling bearing 40 thus reduced, the production cost of the caster 1 is reduced. The first outer ring 41, the second outer ring 42, the first inner ring 43, and the second inner ring 44 are lightweight and thin-walled. This can achieve the weight reduction of the caster 1 and its size reduction in the height direction. As such, according to the caster 1 in the present embodiment, weight reduction as well as downsizing in the height direction are achieved, and the production cost is also reduced.

In the above embodiment, in the cross section including the rotational axis G, the grain flows 41A in the steel constituting the first outer ring 41 extend along the first rolling surface 31, the grain flows 42A in the steel constituting the second outer ring 42 extend along the second rolling surface 32, the grain flows 43A in the steel constituting the first inner ring 43 extend along the third rolling surface 33, and the grain flows 44A in the steel constituting the second inner ring 44 extend along the fourth rolling surface 34. That is, the grain flows in the first rolling surface 31, the second rolling surface 32, the third rolling surface 33, and the fourth rolling surface 34 are each formed continuously without breaks. Adopting such a configuration suppresses the contact of the first rollers 45 and the second rollers 46 with the end portions of the steel grain flows 41A, 42A, 43A, and 44A. Accordingly, the durability of the inner ring 40B and the outer ring 40A is improved.

In the above embodiment, the steel grain flows 41A, 42A, 43A, and 44A are formed continuously along the third surface 416D, the sixth surface 426D, the ninth surface 436D, and the twelfth surface 446D. Adopting such a configuration can suppress the reduction in rigidity of the first outer ring 41, the second outer ring 42, the first inner ring 43, and the second inner ring 44 when attaching the first outer ring 41, the second outer ring 42, the first inner ring 43, and the second inner ring 44 to another member. In addition, the steel grain flows 41A, 42A, 43A, and 44A are formed continuously along the first surface 416B, the fourth surface 426B, the seventh surface 436B, and the tenth surface 446B. Adopting such a configuration can suppress the reduction in rigidity of the first outer ring 41, the second outer ring 42, the first inner ring 43, and the second inner ring 44 when the first rolling surface 31, the second rolling surface 32, the third rolling surface 33, and the fourth rolling surface 34 suffer loads from the first rollers 45 and the second rollers 46.

In the above embodiment, the first outer ring 41 includes the first portion 415, the second portion 416, and the third portion 417. The second outer ring 42 includes the fourth portion 425, the fifth portion 426, and the sixth portion 427. The first inner ring 43 includes the seventh portion 435, the eighth portion 436, and the ninth portion 437. The second inner ring 44 includes the tenth portion 445, the eleventh portion 446, and the twelfth portion 447. The first outer ring 41, the second outer ring 42, the first inner ring 43, and the second inner ring 44 having such configurations can readily be produced, for example, by press forming the steel plates. This can further reduce the production cost of the caster 1.

In the above embodiment, in a cross section including the rotational axis G, the surface 415A of the first portion 415 and the second surface 416C are connected via the curved first surface 416B. The surface 425A of the fourth portion 425 and the fourth surface 426B are connected via the curved fifth surface 426C. The annular space M₁ is formed, enclosed by the first surface 416B, the fourth surface 426B, and the first roller 45. The annular space M₂ is formed, enclosed by the first surface 416B, the fourth surface 426B, and the second roller 46. The annular spaces M₁, M₂ as described above can hold a lubricant. This can reduce the risk of occurrence of oil film shortage between the first roller 45 and the first rolling surface 31 and between the second roller 46 and the second rolling surface 32.

In the above embodiment, in the cross section including the rotational axis G, the thickness T₁ of the first portion 415, the second portion 416, and the third portion 417 is less than 0.5 times the diameter U₁ of the first roller 45 and the diameter R₁ of the second roller 46. The thickness T₃ of the fourth portion 425, the fifth portion 426, and the sixth portion 427 is less than 0.5 times the diameter U₁ of the first roller 45 and the diameter R₁ of the second roller 46. The thickness T₁ of the seventh portion 435, the eighth portion 436, and the ninth portion 437 is less than 0.5 times the diameter U₁ of the first roller 45 and the diameter R₁ of the second roller 46. The thickness T₇ of the tenth portion 445, the eleventh portion 446, and the twelfth portion 447 is less than 0.5 times the diameter U₁ of the first roller 45 and the diameter R₁ of the second roller 46. Adopting such a configuration can reduce the weight of the first outer ring 41, the second outer ring 42, the first inner ring 43, and the second inner ring 44.

In the above embodiment, in the cross section including the rotational axis G, the distance S₁ in the radial direction between the third portion 417 and the ninth portion 437 is smaller than the thickness T₁ of the third portion 417 and the thickness T₅ of the ninth portion 437. The distance S₂ in the radial direction between the sixth portion 427 and the twelfth portion 447 in the cross section including the rotational axis G is smaller than the thickness T₃ of the sixth portion 427 and the thickness T₇ of the twelfth portion 447. Setting the distances S₁ and S₂ in the above ranges can reduce the entry of foreign matter into the space enclosed by the first outer ring 41, the second outer ring 42, the first inner ring 43, and the second inner ring 44 from a gap formed between the third portion 417 and the ninth portion 437 and a gap formed between the sixth portion 427 and the twelfth portion 447.

In the above embodiment, in the cross section including the rotational axis G, the length T₂ of the third portion 417 in the Z axis direction is greater than 1.5 times the thickness T₁ of the third portion 417. The length T₄ of the sixth portion 427 in the Z axis direction is greater than 1.5 times the thickness T₃ of the sixth portion 427. The length T₆ of the ninth portion 437 in the Z axis direction is greater than 1.5 times the thickness T₅ of the ninth portion 437. The length T₅ of the twelfth portion 447 in the Z axis direction is greater than 1.5 times the thickness T₇ of the twelfth portion 447. By adopting such a configuration, when mounting and fixing the first outer ring 41, the second outer ring 42, the first inner ring 43, and the second inner ring 44 to another member, an outer circumferential surface 417B of the third portion 417, an outer circumferential surface 427B of the sixth portion 427, an inner circumferential surface 437B of the ninth portion 437, and an inner circumferential surface 447B of the twelfth portion 447 serve as guide surfaces to facilitate the mounting.

In the above embodiment, in the cross section including the rotational axis G, the third surface 416D and the sixth surface 426D have a curved shape. By adopting such a configuration, the concentration of stress, so-called edge load, caused by the contact between the third surface 416D and the first roller 45 can be reduced. Similarly, the concentration of stress, so-called edge load, caused by the contact between the sixth surface 426D and the second roller 46 can be reduced. This results in a prolonged life of the rolling bearing 40.

In the above embodiment, in the cross section including the rotational axis G, the effective contact length L₁ between the outer circumferential surface 45A of the first roller 45 and the second surface 416C and the effective contact length L₂ between the outer circumferential surface 45A of the first roller 45 and the eleventh surface 446C are not less than 0.5 times and not more than 0.9 times the length U₂ in the axial direction of the first roller 45. The effective contact length L₃ between the outer circumferential surface 46A of the second roller 46 and the fifth surface 426C and the effective contact length L₄ between the outer circumferential surface 46A of the second roller 46 and the eighth surface 436C are not less than 0.5 times and not more than 0.9 times the length R₂ in the axial direction of the second roller 46. With the effective contact lengths L₁ and L₂ in the above range, the frictional force between the first roller 45 and the second and eleventh surfaces 416C and 446C can be reduced. With the effective contact lengths L₂ and L₄ in the above range, the frictional force between the second roller 46 and the fifth and eighth surfaces 426C and 436C can be reduced. This can suppress the increase in rotational torque by the first and second rollers 45 and 46.

In the above embodiment, the first rollers 45 and the second rollers 46 are adopted as the rolling elements. The first rollers 45 and the second rollers 46 are arranged alternately in the circumferential direction. The central axis P of the first rollers 45 intersects the central axis Q of the second rollers 46. The first rollers 45 are arranged to be able to roll on the second surface 416C and the eleventh surface 446C. The second rollers 46 are arranged to be able to roll on the fifth surface 426C and the eighth surface 436C. Adopting the first rollers 45 and the second rollers 46 as the rolling elements makes the rolling bearing 40 suitable for supporting loads applied in a plurality of directions, such as combined loads of radial and thrust loads. Therefore, compared to the case where a plurality of rolling bearings corresponding to loads applied in a plurality of directions are arranged, or the case where a plurality of rows of rolling elements are arranged for respective loads applied in different directions, the increase in the number of parts of the rolling bearing 40 can be suppressed, and downsizing of the caster 1 in the height direction can also be achieved.

In the above embodiment, the case of adopting the first and second rollers 45 and 46 made of steel as the rolling elements has been described. However, not limited to this case, first and second rollers 45 and 46 made of ceramic (for example, alumina or silicon nitride) or made of resin may be adopted. Adopting such rollers as described above can achieve weight reduction of the rolling bearing 40.

The caster 1 in the present embodiment can be suitably used for a carrying cart or the like. For example, the caster 1 can be suitably used for a carrying cart that is used under conditions where loads are applied in a plurality of directions. In particular, the caster 1 in the present embodiment can be used in a carrying cart that is used on unpaved roads, farmland, or the like.

### (Variation)

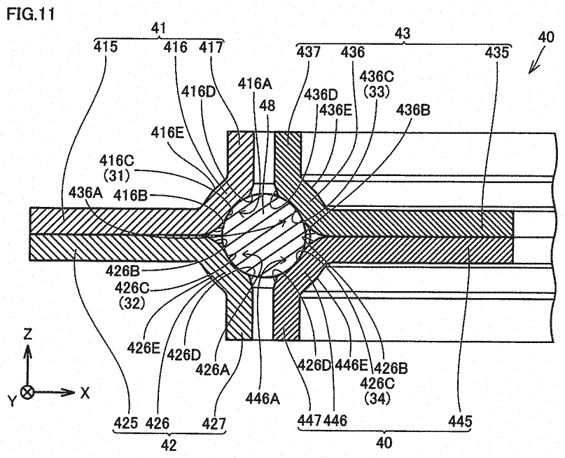

A description will now be made of a variation of the caster 1 in Embodiment 1. Referring to FIG. 11, in the rolling bearing 40 in the present variation, balls 48 are adopted as the rolling elements. In a cross section including the rotational axis G, the second surface 416C has an arc shape with a larger radius of curvature than the surface of the ball 48. In the cross section including the rotational axis G, the second portion 416 has an outer circumferential surface 416E of an arc shape. In the cross section including the rotational axis G, the fifth surface 426C has an arc shape with a larger radius of curvature than the surface of the ball 48. In the cross section including the rotational axis G, the fifth portion 426 has an outer circumferential surface 426E of an arc shape. In the cross section including the rotational axis G, the eighth surface 436C has an arc shape with a larger radius of curvature than the surface of the ball 48. In the cross section including the rotational axis G, the eighth portion 436 has an outer circumferential surface 436E of an arc shape. In the cross section including the rotational axis G, the eleventh surface 446C has an arc shape with a larger radius of curvature than the surface of the ball 48. In the cross section including the rotational axis G, the eleventh portion 446 has an outer circumferential surface 446E of an arc shape. The balls 48 as the rolling elements are arranged to be able to roll while contacting the second surface 416C, the fifth surface 426C, the eighth surface 436C, and the eleventh surface 446C at their outer circumferential surfaces 48A. It should be noted that the four rolling surfaces may be formed to have a gothic arch shape in the cross section including the rotational axis G. Adopting the balls 48 as the rolling elements can reduce the rotational resistance of the rolling bearing 40.

### Embodiment 2

A description will now be made of Embodiment 2 of the caster 1 of the present disclosure. The caster 1 in Embodiment 2 basically has the same structure and produces the same effects as the caster 1 in Embodiment 1. However, Embodiment 2 differs from Embodiment 1 in that the mounting portion 50 includes a cover member, a fixing member, and a seal member. The points that are different from the case of Embodiment 1 will mainly be described below.

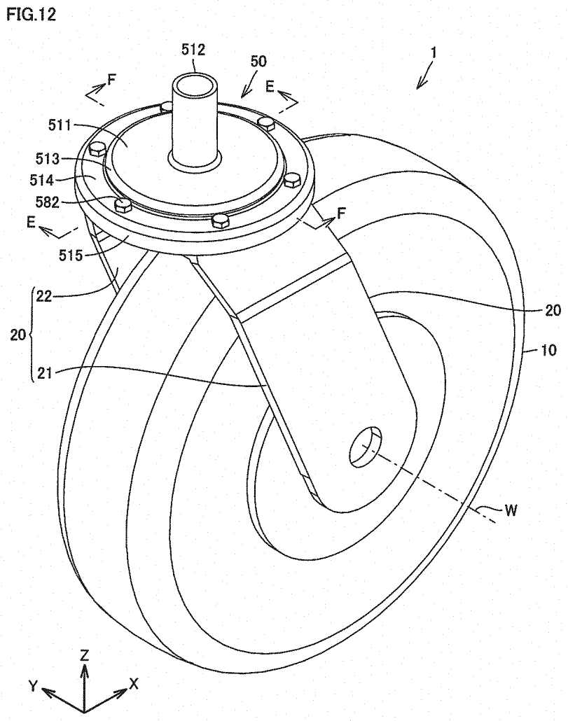

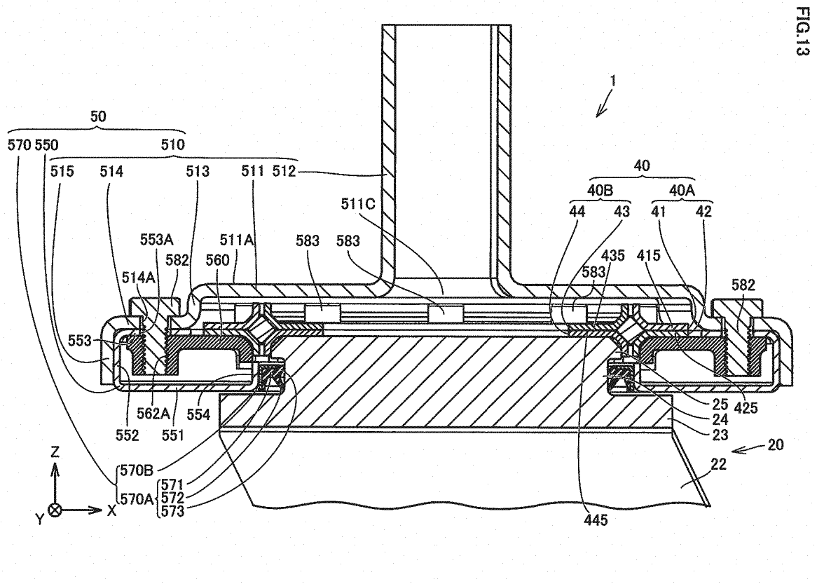

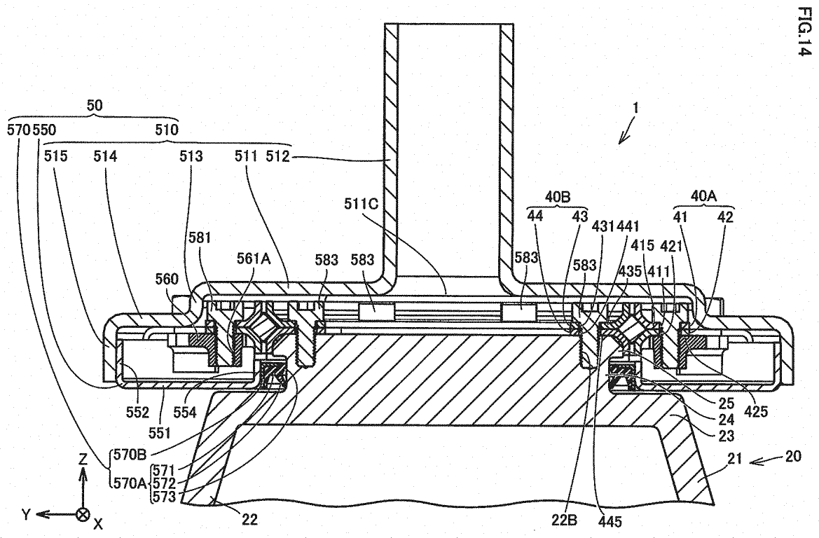

FIG. 12 is a schematic perspective view showing the structure of a caster 1 in Embodiment 2. FIG. 13 is a cross-sectional view of the caster 1 when cut at E-E in FIG. 12. FIG. 14 is a cross-sectional view of the caster 1 when cut at F-F in FIG. 12. Referring to FIGS. 12 to 14, the mounting portion 50 includes a lid 510, a cover member 550, a fixing member 560, and a seal member 570. The lid 510 includes a body portion 511, a shaft portion 512, a first circumferential wall portion 513, an outer circumferential portion 514, and a second circumferential wall portion 515. The body portion 511 has a disk shape. When viewed in a plane in the Z axis direction, the body portion 511 has a through hole 511C formed at its center to penetrate in the thickness direction. The shaft portion 512 protrudes along the Z axis direction from one surface 511A in the thickness direction of the body portion 511. The shaft portion 512 has a hollow cylindrical shape. The shaft portion 512 is arranged such that the space enclosed by the inner wall of the shaft portion 512 communicates with the through hole 511C. The shaft portion 512 is inserted into a slot formed in a member to which the caster 1 is to be attached. The first circumferential wall portion 513 extends from the outer edge of the body portion 511 to the opposite side of the shaft portion 512 in the Z axis direction. The first circumferential wall portion 513 has an annular shape. The outer circumferential portion 514 extends from an end of the first circumferential wall portion 513 opposite to the body portion 511 along a plane (X-Y plane) perpendicular to the Z axis direction. The outer circumferential portion 514 has a flat annular shape. The second circumferential wall portion 515 extends from the outer edge of the outer circumferential portion 514 to the opposite side of the first circumferential wall portion 513 in the Z axis direction. The second circumferential wall portion 515 has an annular shape.

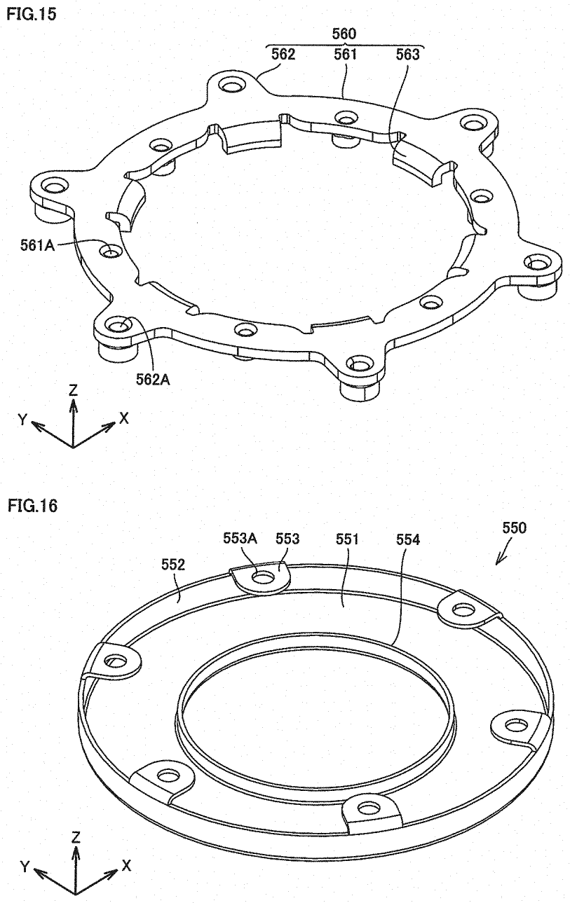

Referring to FIG. 15, the fixing member 560 includes a body portion 561 of a disk shape, protruding portions 562, and hook portions 563. The body portion 561 has a plurality of screw holes 561A, penetrating in the thickness direction, formed at equal intervals in the circumferential direction. A protruding portion 562 and a hook portion 563 are formed between adjacent screw holes 561A in the circumferential direction. The protruding portions 562 protrude in the radial direction from the outer circumference of the body portion 561. A plurality of protruding portions 562 are formed at equal intervals in the circumferential direction. Each protruding portion 562 has a screw hole 562A formed to penetrate along the Z axis direction. In the radial direction, the hook portion 563 is located on the opposite side of the protruding portion 562 as seen from the body portion 561. The hook portions 563 extend along the Z axis direction from the inner circumference of the body portion 561.

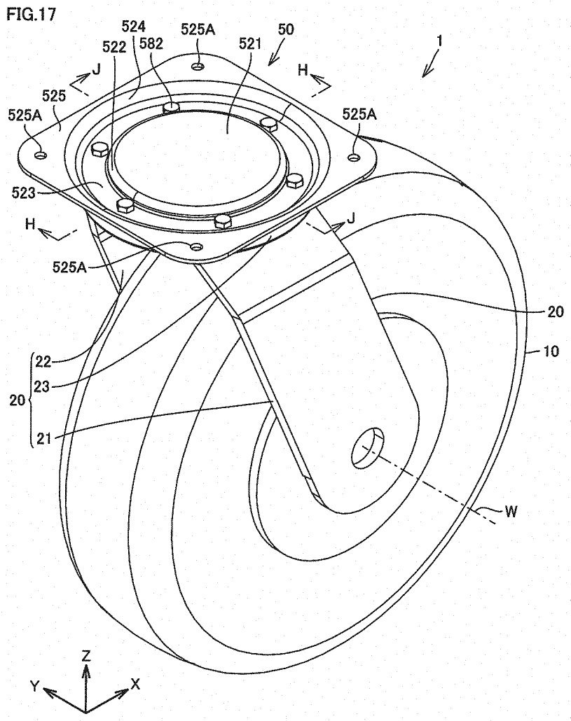

Referring to FIG. 16, the cover member 550 includes a flat annular body portion 551, an outer circumferential wall portion 552, protruding portions 553, and an inner circumferential wall portion 554. The outer circumferential wall portion 552 extends along the Z axis direction from the outer edge of the body portion 551. The outer circumferential wall portion 552 has an annular shape. Each protruding portion 553 is arranged so as to extend radially inward from an end of the outer circumferential wall portion 552 opposite to the body portion 551 in the Z axis direction. The protruding portion 553 has a flat plate shape. The protruding portion 553 has a through hole 553 formed to penetrate in the thickness direction. The inner circumferential wall portion 554 extends along the Z axis direction from the inner edge of the body portion 551. The inner circumferential wall portion 554 has an annular shape.

Referring to FIGS. 13 and 14, the seal member 570 has an annular shape. The seal member 570 includes a rubber member 570A and a metal member 570B. The rubber member 570A has an annular shape. The rubber member 570A includes a body portion 571 of a flat annular shape, and a first lip portion 572 and a second lip portion 573 of an annular shape protruding in the radial direction from the body portion 571. The metal member 570B has a shape in which an outer circumferential portion of a cylindrical shape is connected to the outer edge of a body portion of a flat annular shape. The metal member 570B is in contact with one end face and an outer circumferential surface of the rubber member 570A. The rubber member 570A is fixed to the metal member 570B.

Referring to FIG. 13, the rolling bearing 40 is installed on the fork 20 as the second inner ring 44 is fitted into the flange portion 25. Referring to FIG. 14, the rolling bearing 40 is placed such that the positions where the mounting holes 431 are formed in the seventh portion 435, the positions where the mounting holes 441 are formed m the tenth portion 445, and the positions where the screw holes 22B are formed coincide with each other, and the bolts 583 are screwed into the screw holes 22B through the mounting holes 431 and 441. In this manner, the first inner ring 43 and the second inner ring 44 are fixed to the fork 20.

Referring to FIGS. 15 and 16, the fixing member 560 is fitted into a space in the cover member 550 enclosed by the body portion 551, the outer circumferential wall portion 552, and the inner circumferential wall portion 554. Then, the fixing member 560 is placed such that the positions where the screw holes 562A are formed in the cover member 550 and the positions where the through holes 553A are formed in the fixing member 560 coincide with each other. Referring to FIG. 14, the rolling bearing 40 is placed such that the positions where the mounting holes 411 are formed in the first portion 415, the positions where the mounting holes 421 are formed in the fourth portion 425, and the positions where the screw holes 561A are formed in the fixing member 560 coincide with each other, and bolts 581 are screwed into the screw holes 562A through the mounting holes 411 and 421.

Referring to FIG. 13, the lid 510, the cover member 550, and the fixing member 560 are placed such that the positions where screw holes 514A are formed in the outer circumferential portion 514 of the lid 510, the positions where the through holes 553A are formed in the cover member 550, and the positions where the screw holes 562A are formed in the fixing member 560 coincide with each other, and bolts 582 are screwed into the screw holes 514A, the through holes 553A, and the screw holes 562A together. In this manner, the first outer ring 41 and the second outer ring 42 are fixed to the mounting portion 50. The hook portions 563 abutting against the outer circumferential surface of the second outer ring 42 and the flange portion 25 abutting against the inner circumferential surface of the second inner ring 44 facilitate the centering of the rolling bearing 40.

The seal member 570 is arranged between the outer circumferential surface of the pedestal portion 24 and the inner circumferential surface of the inner circumferential wall portion 554 in the radial direction. In the present embodiment, the metal member 570B is press-fitted into the inner circumferential wall portion 554, whereby the seal member 570 is fixed to the inner circumferential wall portion 554. The seal member 570 is arranged such that the tip ends of the first lip portion 572 and the second lip portion 573 contact the outer circumferential surface of the pedestal portion 24. In the present embodiment, the lid 510 is placed to cover one opening of the outer circumferential wall portion 552 in the cover member 550. With such a configuration adopted, a labyrinth portion is formed. This can reduce the entry of water or foreign matter into the space enclosed by the lid 510 and the cover member 550. In the present embodiment, the seal member 570 is placed between the inner circumferential surface of the outer circumferential wall portion 552 and the outer circumferential surface of the pedestal portion 24. Adopting such a configuration can further reduce the entry of water or foreign matter into the space enclosed by the fork 20 and the mounting portion 50 from the gap formed between the cover member 550 and the fork 20.

According to the caster 1 of Embodiment 2 above as well, similarly as in Embodiment 1, weight reduction as well as downsizing in the height direction can be achieved, and the production cost can also be reduced.

### Embodiment 3

A description will now be made of Embodiment 3 of the caster 1 of the present disclosure. The caster 1 in Embodiment 3 basically has the same structure and produces the same effects as the caster 1 in Embodiment 1. However, Embodiment 3 differs from Embodiment 2 in the configuration of the lid 510. The points that are different from the case of Embodiment 2 will mainly be described below.

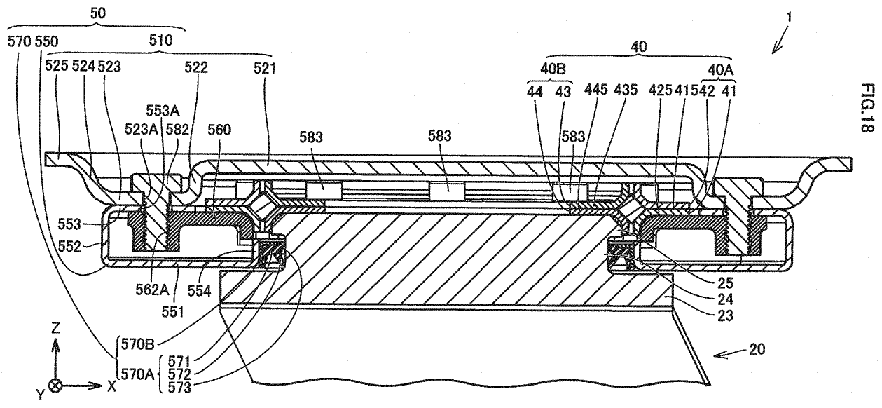

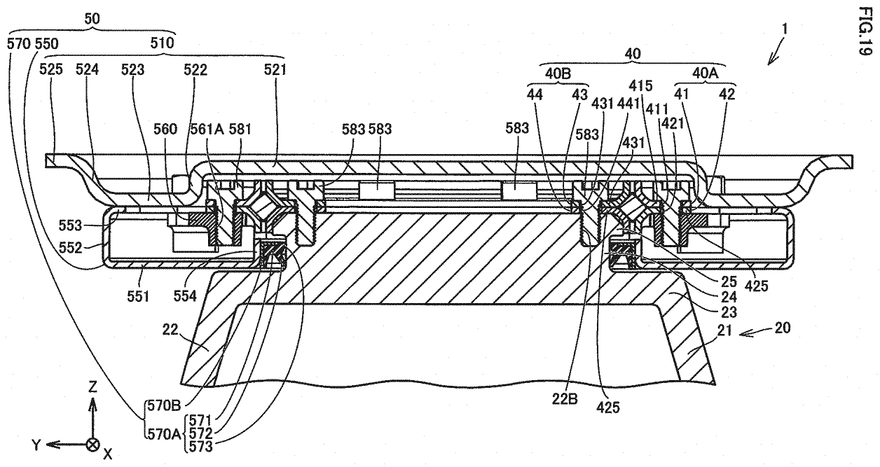

FIG. 17 is a schematic perspective view showing the structure of the caster 1 in Embodiment 3. FIG. 18 is a cross-sectional view of the caster 1 when cut at H-H in FIG. 17. FIG. 19 is a cross-sectional view of the caster 1 when cut at J-A in FIG. 17. Referring to FIGS. 17, 18, and 19, the mounting portion 50 includes a lid 510, a cover member 550, a fixing member 560, and a seal member 570. The lid 510 includes a disk-shaped body portion 521, a first circumferential wall portion 522, a first outer circumferential portion 523, a second circumferential wall portion 524, and a second outer circumferential portion 525. The first circumferential wall portion 522 extends along the Z axis direction from the outer edge of the body portion 521. The first circumferential wall portion 522 has an annular shape. The first outer circumferential portion 523 extends along the radial direction from an end of the first circumferential wall portion 522 opposite to the body portion 521 in the Z axis direction. The first outer circumferential portion 523 has a flat annular shape. The first outer circumferential portion 523 has a plurality of through holes 523A, penetrating in the thickness direction, formed at equal intervals in the circumferential direction. The second circumferential wall portion 524 extends from the outer edge of the first outer circumferential portion 523 to oppose the first circumferential wall portion 522 in the radial direction. The second circumferential wall portion 524 has a flat annular shape. The second outer circumferential portion 525 extends along the radial direction from an end of the second circumferential wall portion 524 opposite to the first outer circumferential portion 523 in the Z axis direction. When viewed in a plane in the Z axis direction, the external shape of the second outer circumferential portion 525 is a rectangular shape with rounded corners. In each of the four corners of the second outer circumferential portion 525, a through hole 525A penetrating in the thickness direction is formed.

The lid 510 is placed such that the positions where the through holes 523A are formed in the first outer circumferential portion 523, the positions where the through holes 553A are formed in the cover member 550, and the positions where the screw holes 562A are formed in the fixing member 560 coincide with each other, and bolts 582 are screwed into the holes. In this manner, the first outer ring 41 and the second outer ring 42 are fixed to the mounting portion 50. The cover member 550 arranged in this manner can reduce the entry of foreign matter into the space enclosed by the fork 20 and the mounting portion 50. Moreover, the arrangement of the cover member 550 and the seal member 570 can further reduce the entry of water or foreign matter into the space enclosed by the fork 20 and the mounting portion 50.

According to the caster 1 of Embodiment 3 above as well, similarly as in Embodiment 1, weight reduction as well as downsizing in the height direction can be achieved, and the production cost can also be reduced.

The caster 1 in the present embodiment is placed such that the positions of screw holes formed in a member to which the caster 1 is to be attached coincide with the positions of the through holes 525A formed in the second outer circumferential portion 525, and screws are screwed into the holes. The caster 1 in the present embodiment is installed in the above-described manner.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1: caster; 10: wheel; 17; 43rd portion; 20: fork; 21.22: support portion; 22B, 502, 502A, 514A, 561A, 562A: screw hole; 23: connecting portion; 24: pedestal portion; 25: flange portion; 31: first rolling surface; 32: second rolling surface; 33: third rolling surface; 34: fourth rolling surface; 37, 437: ninth portion; 40: rolling bearing; 40A: outer ring; 40B: inner ring; 40C: roller; 41: first outer ring; 41A, 42A, 43A, 44A: grain flow; 42: second outer ring; 43: first inner ring; 44: second inner ring; 45: first roller; 45A, 46A. 48A, 416E, 417B, 426E, 427B, 436A, 436E, 437A, 446A, 446E, 447A: outer circumferential surface; 45B, 45C. 46B, 46C: end face; 46: second roller; 48: ball; 50: mounting portion; 411, 421, 431, 441: mounting hole; 412, 423, 432, 443, 502, 553, 562: protruding portion; 413, 422, 433, 442, 443, 501C. 511C. 523A, 525A, 553, 553A: through hole; 415: first portion; 415A, 425A, 435A, 445A, 501A, 511A: surface; 416: second portion; 416A, 417A, 426A, 427A, 437B, 447B: inner circumferential surface; 416B: first surface; 416C: second surface; 416D: third surface; 417: third portion; 425: fourth portion; 426: fifth portion; 426B: fourth surface; 426C: fifth surface; 426D: sixth surface; 427: sixth portion; 435: seventh portion; 436: eighth portion; 436B: seventh surface, 436C: eighth surface; 436D: ninth surface; 445: tenth portion; 446: eleventh portion; 446B: tenth surface; 446C: eleventh surface; 446D: twelfth surface; 447: twelfth portion; 501, 511, 521, 551, 561, 571: body portion; 503, 563: hook portion; 504.512: shaft portion; 510: lid; 513, 522; first circumferential wall portion; 514: outer circumferential portion; 515, 524: second circumferential wall portion. 523: first outer circumferential portion; 525: second outer circumferential portion; 550: cover member; 552: outer circumferential wall portion; 554: inner circumferential wall portion; 560: fixing member; 570: seal member; 570A: rubber member; 570B: metal member; 572: first lip portion; 573: second lip portion; and 581, 582, 583, 584: bolt.

1. A caster comprising:
a wheel;
a first member holding the wheel so as to allow the wheel to rotate about a first rotational axis;
a second member arranged apart from the first member; and
a rolling bearing arranged between the first member and the second member, having a second rotational axis that intersects the first rotational axis, and supporting the first member with respect to the second member so as to allow the first member to rotate about the second rotational axis;
the rolling bearing including
an outer ring fixed to one of the first and second members,
an inner ring fixed to the other of the first and second members, and
a plurality of rolling elements arranged to be able to roll on an inner circumferential surface of the outer ring and an outer circumferential surface of the inner ring,
the outer ring including
a first outer ring made of a steel plate, having a central axis that coincides with the second rotational axis, and having an annular first rolling surface that constitutes the inner circumferential surface of the outer ring, and
a second outer ring made of a steel plate, having a central axis that coincides with the second rotational axis, and having an annular second rolling surface that constitutes the inner circumferential surface of the outer ring, the second outer ring being arranged alongside the first outer ring in a first axis direction in which the second rotational axis extends and being fixed to the first outer ring,
the inner ring including
a first inner ring made of a steel plate, having a central axis that coincides with the second rotational axis, and having an annular third rolling surface that opposes the second rolling surface and constitutes the outer circumferential surface of the inner ring, and
a second inner ring made of a steel plate, having a central axis that coincides with the second rotational axis, and having an annular fourth rolling surface that opposes the first rolling surface and constitutes the outer circumferential surface of the inner ring, a line segment connecting the fourth rolling surface and the first rolling surface and a line segment connecting the second rolling surface and the third rolling surface intersecting in a cross section including the second rotational axis, the second inner ring being arranged alongside the first inner ring in the first axis direction and being fixed to the first inner ring.

2. The caster according to claim 1, wherein in a cross section including the second rotational axis, grain flows in a steel constituting the first outer ring extend along the first rolling surface, grain flows in a steel constituting the second outer ring extend along the second rolling surface, grain flows in a steel constituting the first inner ring extend along the third rolling surface, and grain flows in a steel constituting the second inner ring extend along the fourth rolling surface.

3. The caster according to claim 1, wherein
the first outer ring includes
a first portion having a disk annular shape,
a second portion having a tubular shape and having an annular inner circumferential surface, the second portion extending from an inner edge of the first portion such that an inner diameter of the second portion decreases with increasing distance from the first portion in the first axis direction, and
a third portion having a cylindrical shape, being connected to an end of the second portion opposite to the first portion in the first axis direction, and extending along the first axis direction,
the second outer ring includes
a fourth portion having a disk annular shape and being fixed to the first portion such that main surfaces thereof contact each other,
a fifth portion having a tubular shape and having an annular inner circumferential surface, the fifth portion extending from an inner edge of the fourth portion to a side opposite to the second portion in the first axis direction, the fifth portion having an inner diameter decreasing with increasing distance from the fourth portion, and
a sixth portion having a cylindrical shape, being connected to an end of the fifth portion opposite to the fourth portion in the first axis direction, and extending along the first axis direction to a side opposite to the third portion,
the first inner ring includes
a seventh portion having a disk annular shape,
an eighth portion having a tubular shape and having an annular outer circumferential surface, the eighth portion extending from an outer edge of the seventh portion such that an outer diameter of the eighth portion increases with increasing distance from the seventh portion in the first axis direction, and
a ninth portion having a cylindrical shape, being connected to an end of the eighth portion opposite to the seventh portion in the first axis direction, and extending along the first axis direction,
the second inner ring includes
a tenth portion having a disk annular shape and being fixed to the seventh portion such that main surfaces thereof contact each other,
an eleventh portion having a tubular shape and having an annular outer circumferential surface, the eleventh portion extending from an outer edge of the tenth portion to a side opposite to the eighth portion in the first axis direction such that an outer diameter of the eleventh portion increases with increasing distance from the tenth portion, and
a twelfth portion having a cylindrical shape, being connected to an end of the eleventh portion opposite to the tenth portion in the first axis direction, and extending along the first axis direction to a side opposite to the ninth portion,
the inner circumferential surface of the second portion includes the first rolling surface,
the inner circumferential surface of the fifth portion includes the second rolling surface,
the outer circumferential surface of the eighth portion includes the third rolling surface, and
the outer circumferential surface of the eleventh portion includes the fourth rolling surface.

4. The caster according to claim 3, wherein
in a cross section including the second rotational axis, the main surface of the first portion in contact with the fourth portion and the first rolling surface are connected via a curved first region,
the main surface of the fourth portion in contact with the first portion and the second rolling surface are connected via a curved second region, and
an annular space is formed enclosed by the first region, the second region, and the rolling elements.

5. The caster according to claim 3, wherein
the third portion has an inner circumferential surface opposing an outer circumferential surface of the ninth portion,
the sixth portion has an inner circumferential surface opposing an outer circumferential surface of the twelfth portion, and
in a cross section including the second rotational axis, a distance in a radial direction between the third portion and the ninth portion is smaller than a thickness of the third portion, and a distance in the radial direction between the sixth portion and the twelfth portion is smaller than a thickness of the sixth portion.

6. The caster according to claim 1, wherein
the rolling elements are balls, and
the rolling elements are arranged so as to be able to roll on the first rolling surface, the second rolling surface, the third rolling surface, and the fourth rolling surface.

7. The caster according to claim 1, wherein
the rolling elements include first rollers and second rollers,
the first rollers and the second rollers are arranged alternately in a circumferential direction,
the first rollers and the second rollers have central axes intersecting each other,
the first rollers are arranged so as to be able to roll on the first rolling surface and the fourth rolling surface, and
the second rollers are arranged so as to be able to roll on the second rolling surface and the third rolling surface.
